(19) United States
(12) Patent Application Publication
(10) Pub. No.: US 2017/0075614 A1
(43) Pub. Date: Mar. 16, 2017

(54) MEMORY SYSTEM AND HOST APPARATUS

(71) Applicant: Kabushiki Kaisha Toshiba, Minato-ku (JP)

(72) Inventor: Shinichi KANNO, Ota (JP)

(73) Assignee: Kabushiki Kaisha Toshiba, Minato-ku (JP)

(21) Appl. No.: 15/052,124

(22) Filed: Feb. 24, 2016

(30) Foreign Application Priority Data
Sep. 11, 2015 (JP) 2015-180181

(51) Int. Cl. G06F 3/06

(52) U.S. Cl. CPC G06F 3/0631; G06F 3/0604; G06F 3/0679

(57) ABSTRACT

According to an embodiment, a memory system includes a nonvolatile memory, an interface, and a controller. The nonvolatile memory includes a plurality of unit areas. The unit area is a unit of erase processing of data. The interface receives a plurality of write data each to which a stream identifier is given. The controller circuit writes, to a first unit area, write data which is received by the interface and to which one stream identifier is given. The first unit area is one of the plurality of unit areas and is a unit area to which the one stream identifier is associated. The allocator sets another unit area to a new first unit area after the first unit area becomes full. The allocator associates another stream identifier different from the one stream identifier with the new first unit area.

### CROSS-REFERENCE TO RELATED APPLICATIONS

This application is based upon and claims the benefit of priority from Japanese Patent Application No. 2015-180181, filed on Sep. 11, 2015; the entire contents of which are incorporated herein by reference.

### FIELD

Embodiments described herein relate generally to a memory system and a host apparatus.

### BACKGROUND

In the past, there is a memory system provided with a memory having multiple blocks. A block is the minimum unit which is to be erased in a memory. A multi stream function has been suggested as a function for the memory system. When a memory system having the multi stream function receives a write command including a stream identifier (hereinafter referred to as a stream ID), the memory system having the multi stream function writes data, which have been requested to be written by the write command (hereinafter referred to as write data), to a block according to the stream ID. The stream ID is an identifier selected according to the expected life span of the write data. More specifically, different stream IDs are allocated to two write data of which expected life spans are different.

### BRIEF DESCRIPTION OF THE DRAWINGS

FIG. 1 is an example of a configuration of a computer system on which a memory system according to a first embodiment is implemented;

FIG. 2 is a figure illustrating an example of a configuration of a write IO;

FIG. 3 is a figure illustrating an example of a stream management information;

FIG. 4 is a figure illustrating another example of stream management information;

FIG. 5 is a figure illustrating another example of stream management information;

FIG. 6 is a figure illustrating another example of stream management information;

FIG. 7 is a figure illustrating an example of a state transition of various kinds of blocks;

FIG. 8 is a figure illustrating an example of stream corresponding information;

FIG. 9 is a figure for explaining an example of a configuration of functions provided in a controller;

FIG. 10 is a flow chart for explaining an operation of an OS during writing;

FIG. 11 is a flow chart for explaining an overview of an operation of a memory system according to processing of a write IO;

FIG. 12 is a flow chart for explaining an operation of a memory system according to the first embodiment with regard to the change of the allocation of an input block;

FIG. 13 is a figure for explaining an example of a configuration of functions provided in a controller according to a second embodiment;

FIG. 14 is a flow chart for explaining an operation of a memory system according to a second embodiment with regard to the change of the allocation of an input block;

FIG. 15 is a flow chart for explaining an operation of a memory system according to a third embodiment with regard to the change of the allocation of an input block; and

FIG. 16 is a figure illustrating an example of an implementation of a memory system.

### DETAILED DESCRIPTION

In general, according to one embodiment, a memory system includes a nonvolatile memory, an interface, and a controller. The nonvolatile memory includes a plurality of unit areas. The unit area is a unit of erase processing of data. The interface receives a plurality of write data each to which a stream identifier is given. The controller circuit writes, to a first unit area, write data which is received by the interface and to which one stream identifier is given. The first unit area is one of the plurality of unit areas and is a unit area to which the one stream identifier is associated. The allocator sets another unit area to a new first unit area after the first unit area becomes full. The allocator associates another stream identifier different from the one stream identifier with the new first unit area.

Exemplary embodiments of a memory system and a host apparatus will be explained below in detail with reference to the accompanying drawings. The present invention is not limited to the following embodiments.

### First Embodiment

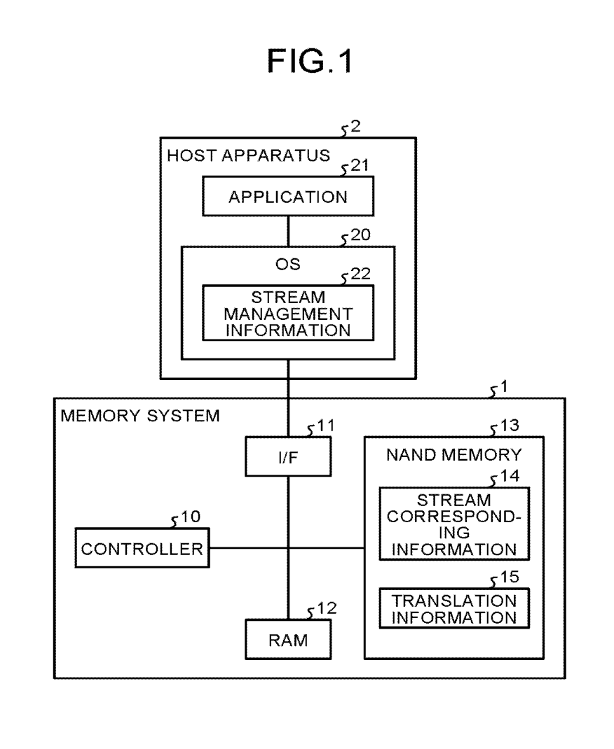

FIG. 1 is an example of a configuration of a computer system on which a memory system according to the first embodiment is implemented. The computer system includes a memory system 1 and a host apparatus (hereinafter referred to as a host) 2. The memory system 1 is connected to the host 2 via a communication path. The memory system 1 functions as an external storage device for the host 2. Any standard may be employed as the standard for the communication path connecting the memory system 1 and the host 2.

The host 2 is a computer provided with a file system driver. The computer includes, for example, a personal computer, a server, a portable information device, or an audio and visual device. In the host 2, an OS 20 and one or more applications 21 are executed. The application 21 executes input and output of data to/from the memory system 1 via the file system driver.

The file system driver is, for example, a part of a function of the operating system (OS) 20. The OS 20 includes, for example, an operating system for a real machine or an operating system for a virtual machine. The operating system for the virtual machine is known as a hypervisor. The file system driver manages one or more data structures. Each of one or more data structures is registered to the stream management information 22. The file system driver refers to the stream management information 22 in order to give a stream ID to the data to be written. A write IO is, for example, input and output processing for the memory system 1, which is issued by the OS 20 in order to write, to the memory system 1, the data which are requested to be written by the application 21. After the application 21 generates data to be written, the application 21 transmits a write request to the OS 20. In response to reception of the write request, the OS 20 issues a write IO for writing the data, which are to be written, to the memory system 1. The source that generates the data to be written is not limited to only the application 21. For example, the OS 20 may generate the data to be written. The write IO includes the data to be written and the write command. Hereinafter, the data to be written included in the write IO will be denoted as write data. It should be noted that the data which the application 21 and the like requests the OS 20 to write are divided into multiple write data by the OS 20, and the multiple write data may be transmitted by respectively different write IOs to the memory system 1.

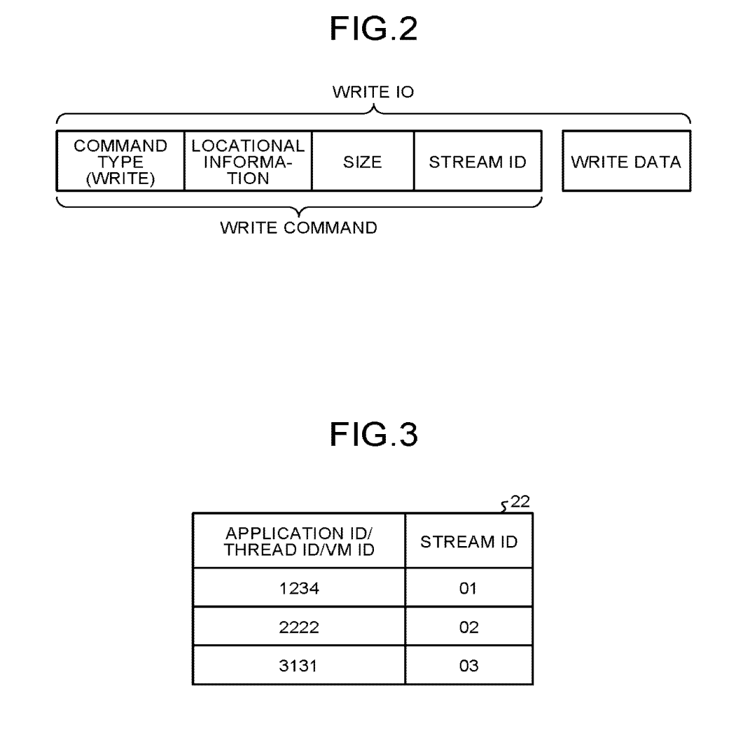

FIG. 2 is a figure illustrating an example of a configuration of a write IO. The write IO includes a write command and write data. The write command includes a command type indicating a write command, locational information indicating the location of the write data, the size of the write data, and a stream identifier (stream ID). The locational information is expressed by an address in an address space which the host 2 maps with the memory system 1. For example, the locational information is expressed in a format of an LBA (Logical Block Address). The locational information may be expressed as any given format. The locational information which the host 2 uses to designate the location of the write data for the memory system 1 will be denoted as a logical address.

In this case, for example, the stream ID is an identifier selected according to an expected life span of data. The life span of the data is a period of time from when the data are written to the memory system 1 to when the data are rewritten. The rewriting includes causing the host 2 to issue, multiple times, a write IO by designating an overlapping logical address. It should be noted that the rewriting includes processing for solving a relation between a logical address and a physical address. The processing for solving the relation between the logical address and the physical address is executed in response to, for example, a TRIM command or an UNMAP command.

As described above, the write command and the write data including the stream ID make a pair to constitute a write IO. In this configuration, each of the write data received by the memory system 1 is associated with the stream ID. It should be noted that when a stream ID is associated with write data, this may also be expressed in such a manner that a stream ID is given to write data. When a stream ID is recorded to a write command, this may also be expressed in such a manner that a stream ID is given to a write command/write data. When a stream ID is given to a write command/write data, this may also be expressed in such a manner that a stream ID is allocated to a write command/write data, or a stream ID is associated with a write command/write data.

The stream management information 22 is information for allowing the OS 20 to obtain the stream ID which is given to the write data. Any given format may be employed as a format of the stream management information 22. For example, a table format may be employed as a format of the stream management information 22. According to the stream management information 22, the same stream ID is associated with two data of which expected life spans of data are about the same. According to the stream management information 22, different stream IDs are associated with two data of which expected life spans of data are different. One or more data associated with the same stream ID are denoted as a stream. The stream ID is an identifier for identifying a stream. An attribute of a data structure is used as information for determining the expected life span of data. More specifically, a relation between an attribute of a data structure and a stream is recorded in the stream management information 22 records. Any given configuration may be employed as the configuration of the stream management information 22. For example, the stream management information 22 is information in a table format configured to be able to obtain a stream ID by using an attribute as the search key. Any given type of attribute correlated with the expected life span of data may be used as the attribute associated with the stream. It should be noted that the attribute selected on the basis of criteria different from the expected life span of data may be employed as the attribute associated with the stream.

FIG. 3 is a figure illustrating an example of the stream management information 22. According to this example, an application ID, a virtual machine ID (VM ID), or a thread ID is associated with a stream. The application ID is an identifier for identifying the application 21. In a case where the application 21 is a virtual machine, the VM ID is employed as the attribute for searching the stream management information 22. The VM ID is an identifier for identifying the virtual machine. The thread ID is a unit of processing executed by the host 2. For example, a single application 21 generates one or more threads. According to the stream management information 22 of FIG. 3, for example, in a case where a write IO is generated so that a virtual machine of which VM ID is “1234” outputs data, a stream ID “01” is given to the write command included in the write IO. For example, in a case where a write IO is generated so that a virtual machine of which VM ID is “2222” outputs data, a stream ID “02” is given to the write command included in the write IO. As described above, an identifier for identifying the source of output of data may be employed as the attribute recorded to the stream management information 22. When the OS 20 issues a write IO, the source of output of write data included in the write IO is identified, and the stream management information 22 is searched by using the identifier of the identified source of output as the search key. It should be noted that not all of the sources of outputs may not be necessarily associated with different stream IDs in one-to-one manner. Some of multiple sources of outputs may be associated with the same stream ID.

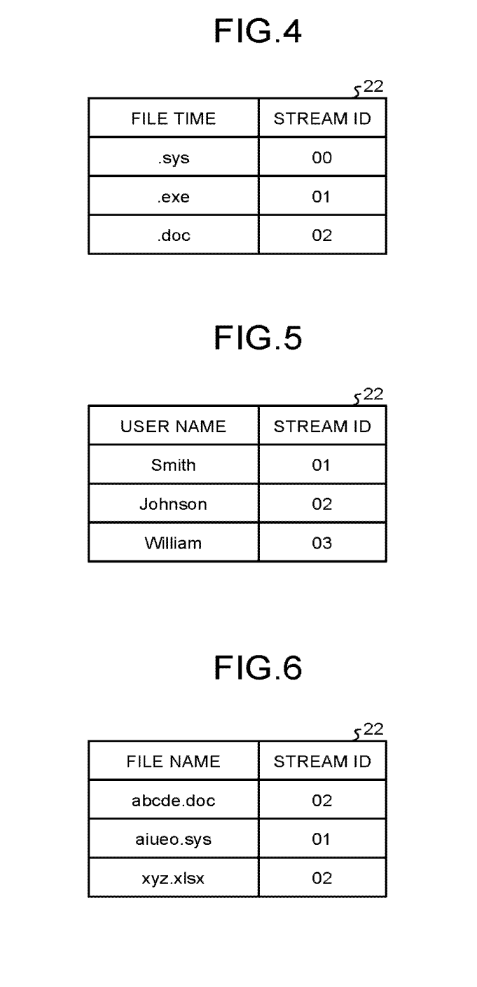

FIG. 4 is a figure illustrating another example of the stream management information 22. According to this example, the type of a file constituting the write data is associated with the stream. The type of the file is identified by an extension. For example, according to the stream management information 22 of FIG. 4, in a case where a write IO for outputting data constituting a file having an extension “.sys” is generated, a stream ID “00” is given to the write command included in the write IO. For example, in a case where a write IO for outputting data constituting a file having an extension “.doc” is generated, a stream ID “02” is given to the write command included in the write IO. As described above, the type of the file constituted by the write data may be employed as the attribute recorded to the stream management information 22. When the OS 20 issues a write IO, the extension of the file constituted by the write data included in the write IO is identified, and the stream management information 22 is searched by using the identified extension as the search key. It should be noted that not all of the types may not be necessarily associated with different stream IDs in one-to-one manner. Some of multiple types may be associated with the same stream ID.

FIG. 5 is a figure illustrating another example of the stream management information 22. According to this example, the name of the user who uses the application 21, the thread, or the virtual machine (hereinafter referred to as a user name) is associated with a thread. For example, according to the stream management information 22 of FIG. 5, when the user whose user name is “Smith” operates the application 21 or the thread to generate a write IO with which the application 21 or the thread outputs data, the stream ID “01” is given to the write command included in the write IO. For example, when the user whose user name is “Johnson” operates the application 21 or the thread to generate a write IO with which the application 21 or the thread outputs data, the stream ID “02” is given to the write command included in the write IO. As described above, the user name may be employed as the attribute recorded to the stream management information 22. When the OS 20 issues a write IO, the user name of the user who operates the source of output of the write data included in the write IO is identified, and the stream management information 22 is searched by using the identified user name as the search key. It should be noted that not all of the user names may be necessarily associated with different stream IDs in one-to-one manner. Some of multiple user names may be associated with the same stream ID.

FIG. 6 is a figure illustrating another example of the stream management information 22. According to this example, the name of the file constituting the write data (hereinafter referred to as a file name) is associated with the stream. For example, according to the stream management information 22 of FIG. 6, for example, in a case where a write IO for outputting data constituting a file having a file name “abcde.doc” is generated, the stream ID “02” is given to the write command included in the write IO. For example, in a case where a write IO for outputting data constituting a file having a file name “aiueo.sys” is generated, the stream ID “01” is given to the write command included in the write IO. As described above, the name of the file constituted by the write data may be employed as the attribute recorded to the stream management information 22. When the OS 20 issues a write IO, the name of the file constituted by the write data included in the write IO is identified, and the stream management information 22 is searched by using the identified name as the search key. It should be noted that not all of the file names may be necessarily associated with different stream IDs in one-to-one manner. Some of multiple file names may be associated with the same stream ID.

As long as a write command/write data provided with a stream ID can be issued, the example of the configuration of the host 2 is not limited to the above. For example, giving of the stream ID may be executed by a constituent element other than the OS 20. For example, the user may determine the stream ID, and may give the determined stream ID to the write data. Alternatively, the application 21 may determine the stream ID, and may give the determined stream ID to the write data.

For example, the host 2 includes an arithmetic operation device and a storage device. The arithmetic operation device is a circuit operating on the basis of a program. The storage device of the host 2 includes a program achieving the function of the application 21 and a program achieving the function of the OS 20. The arithmetic operation device of the host 2 achieves the function of the OS 20 and the function of the application 21 by executing each program stored in the storage device of the host 2.

The memory system 1 includes a controller 10, an interface (I/F) 11, a RAM (Random Access Memory) 12, and a NAND memory 13.

The I/F 11 is an interface device for communicating with the host 2. The I/F 11 receives a write IO from the host 2. In other words, the I/F 11 receives write data attached with a stream ID.

The controller 10 processes the write IO received by the I/F 11. More specifically, the controller 10 controls storing of the write data included in the write IO to the storage area. The storage area to which the write data are stored includes the RAM 12 and the NAND memory 13. The controller 10 is, for example, an arithmetic operation device which is a circuit operating on the basis of a program. The arithmetic operation device achieves various kinds of function as the controller 10 by executing the program. The configuration of various kinds of functions provided in the controller 10 will be explained later.

The RAM 12 is a memory that functions as a temporary storage area. The temporary storage area includes a storage area, a cache, a buffer, which stores data erased in a short period of time or frequently used, or a storage area into which a program is extracted. The type of a memory that functions as the temporary storage area may be a DRAM (Dynamic Random Access Memory) or an SRAM (Static Random Access Memory). The type of a memory that functions as a temporary storage area is not limited to only the RAM. A memory capable of performing access at a speed higher than the NAND memory 13 may be employed as the memory that functions as the temporary storage area. A volatile or nonvolatile memory may be employed as the memory that functions as the temporary storage area.

More specifically, the NAND memory 13 is a NAND-type flash memory. The NAND memory 13 is a memory that functions as a storage in the memory system 1. More specifically, write data are stored to the NAND memory 13. The type of the memory that functions as the storage is not limited to only the NAND-type flash memory. A memory in which any given type of memory functions as a storage may be employed as long as it is a nonvolatile memory.

The NAND memory 13 includes multiple blocks. The block is the minimum unit area with which processing of erasing can be performed on data stored in the NAND memory 13. More specifically, data stored in a single block are erased at a time. It should be noted that the minimum unit area of the processing of erasing may be constituted by multiple blocks. Each block includes multiple pages. The processing of write of data and the processing of read of data performed on the NAND memory 13 can be executed in units of pages.

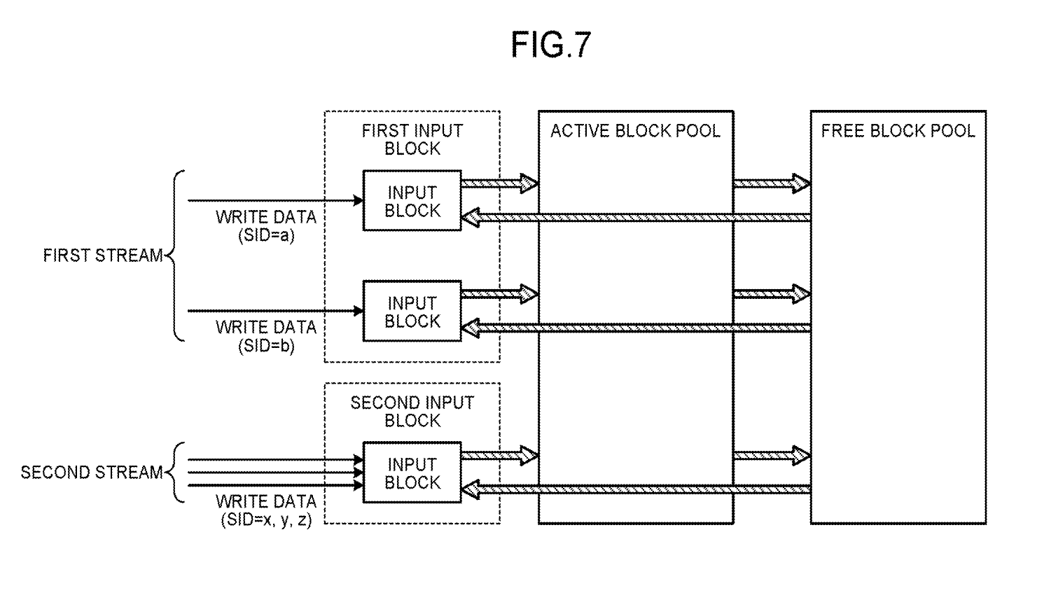

The state transition of the block will be explained. FIG. 7 is a figure illustrating an example of state transitions of various kinds of blocks. A hatched arrow indicates a state transition of a block, and an arrow of a solid line indicates movement of data. The states of the blocks include at least an input block, an active block, and a free block. One or more active blocks constitute an active block pool, and one or more free blocks constitute a free block pool.

The input block is a block that is set as a block to which write data are written. More specifically, the input block includes a vacant page, and write data are planned to be written to the vacant page. The active block is a block for which writing has been finished and which is not yet reusable. A block for which writing has been finished and which stores valid user data is managed as an active block. “Reuse” means transition to the input block. The free block means a reusable block.

For example, after data for a single block are written to the input block, the input block changes to the active block. The state of the write data stored in the active block is either a valid state or an invalid state. In a case where, in a state in which first write data are stored in the active block, second write data are sent from the host 2 by designating the same logical address as that of the first write data, the controller 10 writes the second write data to the vacant page of the input block, and manages, as the invalid write data, the first write data stored in the active block. When the write data are valid, this means that the write data in question is in the latest state. In a case where multiple write data designating the same logical address are stored to the NAND memory 13, the latest state means the state of one of the multiple write data that was written lastly by the host 2. The invalid write data mean write data of multiple write data which are stored in the NAND memory 13 by designating the same logical address and which are other than the write data written lastly by the host 2. In this case, the “vacant” state means a state in which neither the invalid data nor the valid data are stored. The vacant page is a vacant area to which data can be written.

Whether the user data are valid or invalid can be determined from translation information 15 explained later. For example, the valid user data are user data stored at a location associated with a logical address by the translation information 15. The invalid user data are user data stored at a location not associated with a logical address by the translation information 15. It should be noted that whether the user data are valid or invalid may be managed in such a manner that it can be determined by a flag for each of user data. Any given method other than the above may be employed as the management method for determining whether the user data are valid or invalid.

When free blocks are insufficient, garbage collection is executed. The garbage collection is processing for moving (copying) valid write data from an active block to a vacant page in another block, and thereafter, managing, as invalid data, all the write data stored in the active block in the source of moving. After the garbage collection, the active block in the source of moving changes to a free block. The block of the destination of moving may be an input block, or may be a dedicated block for the garbage collection. The free block changes to an input block after the erasing is executed so that the free block is changed to a vacant state.

Multiple input blocks are prepared. A stream is associated with each input block. More specifically, the input block to which the write data are written is selected according to the stream.

According to the first embodiment, multiple input blocks include the first input block and the second input block. The first input block is an input block allocated to only a single stream. The write data which belong to the single stream to which the first input block is allocated are written to the single first input block. The second input block is an input block to which write data other than the write data which belong to the stream to which the first input block is allocated are written. The write data which belong to the stream to which the first input block is not allocated are written to the second input block.

Hereinafter, a stream to which the first input block is allocated will be denoted as a first stream. A stream to which the second input block is allocated will be denoted as a second stream.

According to the example of FIG. 7, a stream of which stream ID is “a” and a stream of which stream ID is “b” correspond to the first stream. A stream of which stream ID is “x”, a stream of which stream ID is “y”, and a stream of which stream ID is “z” correspond to the second stream.

It should be noted that the number of first input blocks may be one, or may be two or more. The number of second input blocks may be one, or may be two or more. The number of blocks included in the NAND memory 13 is finite. Therefore, for example, the number of first input blocks and the number of second input blocks are fixed. The upper limit value of the number of first input blocks may be fixed. The upper limit value of the number of second input blocks may be fixed. The summation of the number of first input blocks and the number of second input blocks may be fixed.

According to the first embodiment, the controller 10 automatically executes allocation of an input block to a stream in accordance with an input situation of user data from the host 2. In other words, the controller 10 dynamically changes a relation between a stream and an input block.

When write data are written to the NAND memory 13, the controller 10 refers to management information stored in the NAND memory 13. The controller 10 updates the management information according to the situation. The management information may be cached to the RAM 12. More specifically, the controller 10 may load the management information to the RAM 12, or may refer to and update the management information loaded to the RAM 12. In a case where the controller 10 updates the management information, at least an updated portion of the management information on the RAM 12 is stored to the NAND memory 13 with predetermined timing.

The management information includes at least stream corresponding information 14 and translation information 15. The stream corresponding information 14 is information for associating a stream and an input block. The translation information 15 is information for associating a logical address with a physical location on the NAND memory 13.

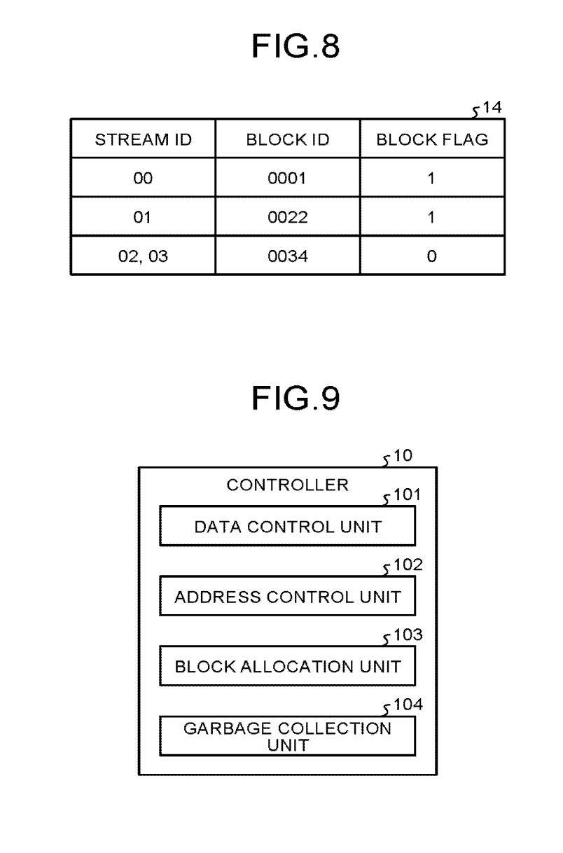

FIG. 8 is a figure illustrating an example of the stream corresponding information 14. In this case, each block is identified by a block ID. According to this example, a stream of which stream ID is “00” is associated with an input block of which block ID is “0001”. For example, a stream of which stream ID is “01” is associated with an input block of which block ID is “0022”. For example, a stream of which stream ID is “02” and a stream of which stream ID is “03” are associated with an input block of which block ID is “0034”. Each of the input block of which block ID is “0001” and the input block of which block ID is “0022” corresponds to the first input block. More specifically, each of the stream of which stream ID is “00” and the stream of which stream ID is “01” corresponds to the first stream. The input block of which block ID is “0034” corresponds to the second input block. More specifically, each of the stream of which stream ID is “02” and the stream of which stream ID is “03” corresponds to the second stream.

According to the example of FIG. 8, the stream corresponding information 14 includes a block flag. The block flag is information indicating whether it is the first input block or the second input block. More specifically, the block flag is management information indicating the input block which is set in the first input block. In this case, “1” indicates the first input block, and “0” indicates the second input block.

The stream corresponding information 14 may be configured such that the relation between the input block and the stream according to the second input block is omitted. In that case, the stream not recorded in the stream corresponding information 14 can be determined to be the second stream. Further, for example, the second input block is managed separately from the stream corresponding information 14, and the write data which belong to the second stream are identified such that the second input block managed separately from the stream corresponding information 14 is the destination of writing.

FIG. 9 is a figure for explaining an example of a configuration of the functions provided in the controller 10. The controller 10 includes a data control unit 101, an address control unit 102, a block allocation unit (allocator) 103, and a garbage collection unit 104.

The data control unit 101 stores the write data included in the write IO to the RAM 12 and to the NAND memory 13. For example, the data control unit 101 once stores the write data to the RAM 12. Then, the data control unit 101 writes the write data stored in the RAM 12 to the NAND memory 13 with predetermined timing. When the data control unit 101 writes the write data to the NAND memory 13, the data control unit 101 selects an input block of the destination of writing by referring to the stream corresponding information 14. The data control unit 101 determines the input block of the destination of writing in accordance with the stream ID and the stream corresponding information 14. In a case where an input block changes to an active block, the data control unit 101 generates a new input block from the free block.

The block allocation unit 103 executes allocation of an input block for a stream and the change of the allocation of the input block between a stream and an input block. In the first embodiment, in a case where a new input block is generated, and the controller 10 receives a write IO which belongs to a stream to which no input block is allocated in a state where the input block is allocated to none of the streams, the block allocation unit 103 allocates the new input block to the stream to which no input block is allocated. The block allocation unit 103 reflects, in the stream corresponding information 14, an allocation result every time allocation is executed.

The garbage collection unit 104 executes the garbage collection. The garbage collection unit 104 may execute the garbage collection without considering a stream which the write data stored in each active block belong to, and may execute the garbage collection so that two write data which belong to the same stream move to different blocks. For example, the garbage collection unit 104 stores the stream ID for each of write data (or for each active block), and moves each of the write data stored in the block, which is the source of moving, to the input block allocated to the stream to which the write data belong.

The address control unit 102 updates the translation information 15 in accordance with a writing of write data by the data control unit 101 to the NAND memory 13 and a writing of write data by the garbage collection unit 104 to the NAND memory 13.

It should be noted that some or all of the constituent elements (the data control unit 101, the address control unit 102, the block allocation unit 103, and the garbage collection unit 104) provided in the controller 10 may be achieved by a hardware circuit or a combination of a hardware circuit and an arithmetic operation device. The hardware circuit is a circuit that does not require any program. Two or more of the constituent elements provided in the controller 10 may be achieved by a single constituent element. One of the constituent elements provided in the controller 10 may be achieved by multiple constituent elements. Some or all of the data control unit 101, the address control unit 102, the block allocation unit 103, and the garbage collection unit 104 may be provided outside of the controller 10.

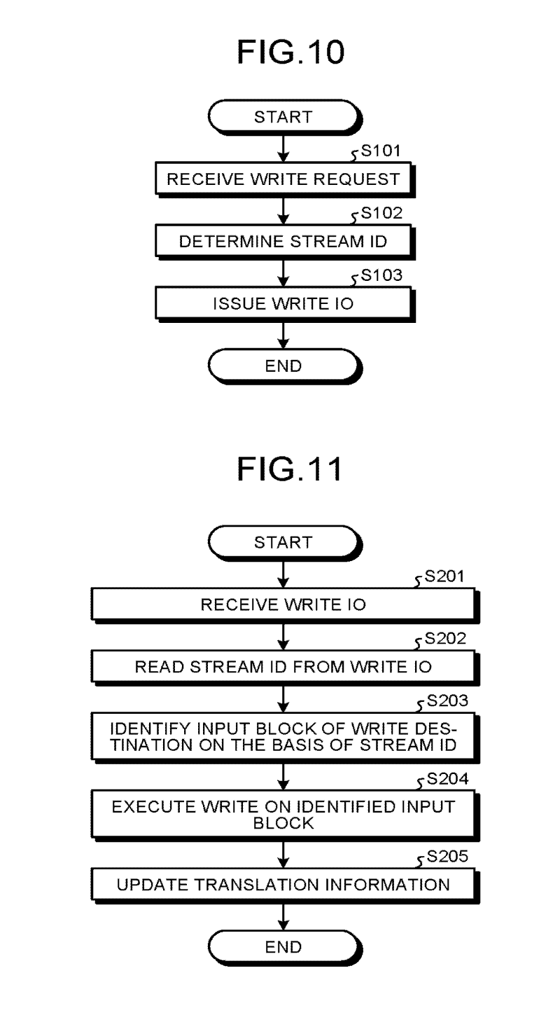

FIG. 10 is a flow chart for explaining an operation of the OS 20 during writing. When the application 21 (or a thread or a VM) issues a write request, the OS 20 (more specifically, a file system driver in the OS 20) receives the write request (S101). The OS 20 determines the stream ID allocated to the write data by referring to the stream management information 22 (S102). The file system driver issues a write IO including the write data and the write command to the memory system 1 (S103), and then, the operation of the OS 20 during writing is finished. It should be noted that write command included in the write IO issued by the processing of S103 is recorded with the stream ID determined in the processing of S102.

FIG. 11 is a flow chart for explaining an overview of an operation of the memory system 1 according to the processing of the write IO. When the controller 10 receives the write IO (S201), the data control unit 101 reads the stream ID from the write command included in the write IO (S202). The data control unit 101 identifies the input block of the destination of writing by searching the stream corresponding information 14 by using the stream ID (S203), and executes writing of the write data to the identified input block (S204). The address control unit 102 updates the translation information 15 in accordance with the writing of the write data to the input block (S205), and then, the processing of the write IO is finished.

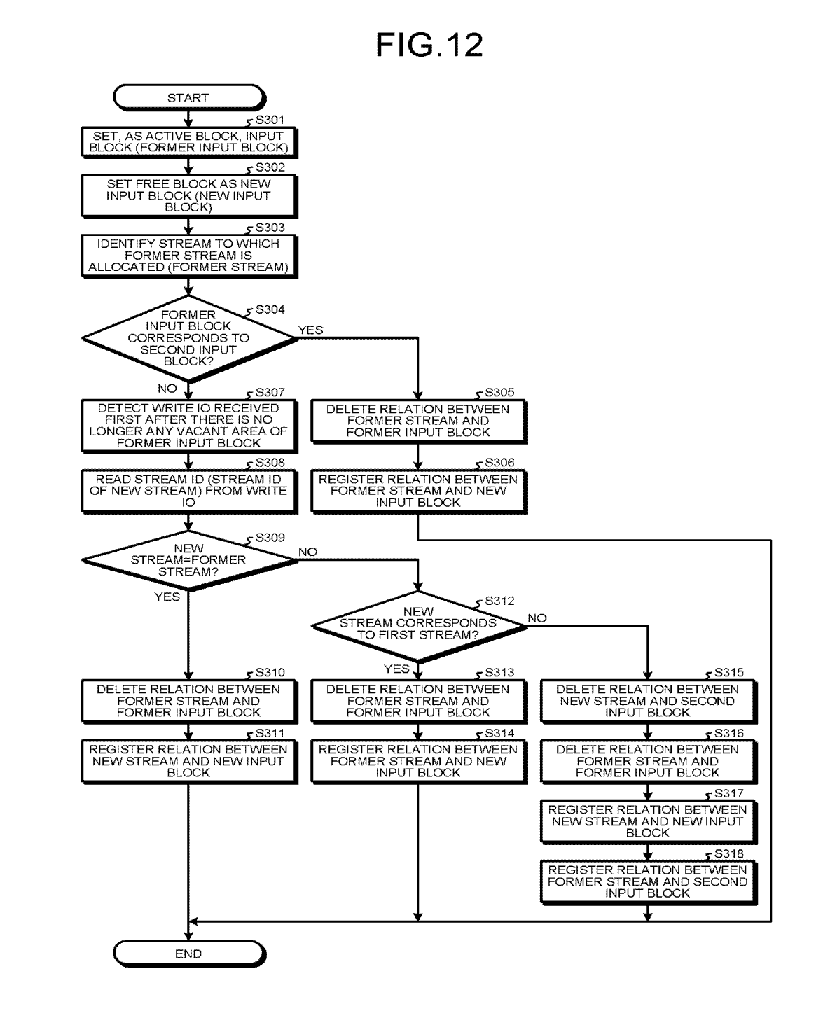

When the input block becomes full due to the processing of the write IO, the controller 10 executes the change of the allocation of the input block. FIG. 12 is a flow chart for explaining an operation of the memory system 1 according to the first embodiment with regard to the change of the allocation of the input block. In a case where there is no vacant area in the input block, the data control unit 101 sets the input block, in which there is no vacant area, as an active block (S301). In the explanation about this drawing, the input block which is set as the active block by the processing of S301 will be denoted as a former input block.

It should be noted that any given method may be employed as the management method of input blocks, active blocks, and free blocks. For example, an input block list recorded with block IDs of blocks which are set as input blocks, an active block list recorded with block IDs of blocks which are set as active blocks, and a free block list recorded with block IDs of blocks which are set as free blocks are included in the management information, each constituent element of the controller 10 updates the input block list, the active block list, and the free block list as necessary. The stream corresponding information 14 may function as the input block list. State information describing a state of each block (input blocks/active blocks/free blocks) may be included in the update information, and the controller 10 may be configured to update the state information as necessary. Flag information indicating a state of each block may be recorded to a predetermined location of the block, and the controller 10 may be configured to be able to update flag information as necessary.

After the processing of S301, the data control unit 101 sets a single free block as a new input block (S302). More specifically, the data control unit 101 selects a single free block, executes erasing on the selected free block, and sets the free block, on which the erasing has been executed, as a new input block. In the explanation about this drawing, a new input block that is set in the processing of S302 will be denoted as a new input block. It should be noted that the order of the processing of S301 and the processing of S302 may be in the opposite order.

The block allocation unit 103 identifies a stream to which a former input block is allocated (S303). In the explanation about this drawing, the stream identified in the processing of S303 will be denoted as a former stream. Further, the block allocation unit 103 determines whether the former input block corresponds to a second input block or not (S304). The block allocation unit 103 executes the processing of S303 and S304 by referring to the stream corresponding information 14.

In a case where the former input block corresponds to the second input block (S304, Yes), the block allocation unit 103 deletes the relation between the former stream and the former input block from the stream corresponding information 14 (S305), and registers a relation between the former stream and the new input block (S306). In the processing of S306, the block allocation unit 103 records the new input block as the second input block. The processing of S305 and S306 can also be achieved by overwriting the block ID of the former input block recorded in the stream corresponding information 14 with the block ID of the new input block.

In a case where the former input block does not correspond to the second input block (S304, No), and more specifically, in a case where the former input block corresponds to the first input block, the block allocation unit 103 monitors reception of the write IO, and detects the write IO that is received first after there is no longer any vacant area in the former input block (S307). The block allocation unit 103 reads the stream ID from the write command included in the detected write IO (S308). The stream indicated by the stream ID that is read in the processing of S308 will be denoted as a new stream.

The block allocation unit 103 determines whether a new stream and a former stream are the same stream or not (S309). In a case where the new stream and the former stream are the same stream (S309, Yes), the block allocation unit 103 deletes the relation between the former stream and the former input block from the stream corresponding information 14 (S310), and registers the relation between the new stream and the new input block (S311). In the processing of S311, the block allocation unit 103 records the new input block as a first input block. The processing of S310 and S311 can also be achieved by overwriting the block ID of the former input block recorded in the stream corresponding information 14 with the block ID of the new input block.

In a case where the new stream and the former stream are different streams (S309, No), the block allocation unit 103 determines whether the new stream corresponds to a first stream or not (S312). More specifically, the block allocation unit 103 determines whether the first input block is allocated to the new stream or not. In a case where the new stream corresponds to the first stream (S312, Yes), and more specifically, in a case where the first input block is allocated to the new stream, the block allocation unit 103 deletes the relation between the former stream and the former input block (S313), and registers the relation between the former stream and the new input block (S314). In the processing of S313, the block allocation unit 103 records the new input block as a first input block. The processing of S313 and S314 can also be achieved by overwriting the block ID of the former input block recorded in the stream corresponding information 14 with the block ID of the new input block.

In a case where the new stream does not correspond to the first stream (S312, No), and more specifically, in a case where the second input block is allocated to the new stream, the block allocation unit 103 deletes the relation between the new stream and the second input block (S315), and deletes the relation between the former stream and the former input block (S316). The block allocation unit 103 registers the relation between the new stream and the new input block (S317), and registers the relation between the former stream and the second input block (S318). The processing of S315 and S317 can also be achieved by overwriting the stream ID of the new stream recorded in the stream corresponding information 14 with the stream ID of the former stream.

After the processing of S306, S311, S314, or S318, the processing of the change of the allocation of the input block is finished.

When there is no longer any vacant area in the input block, the input block is changed to the active block. In the input block, a vacant area may remain in the input block, or the input block may be changed to the active block. In the input block, the vacant area may be padded with predetermined data, and thereafter, the input block may be changed to the active block. More specifically, the input block can be changed to an active block with any given timing. When the input block is changed to the active block, this means that the writing of the input block is finished.

As described above, according to the first embodiment, after writing of the write data to the first input block is finished, the block allocation unit 103 sets the block as a new first input block, and associates another stream, which is different from the former stream, with the new first input block (S315 to S318). In accordance with a new setting of the input block, the block allocation unit 103 changes the former stream, which was the first stream, into the second stream, and changes the new stream, which was the second stream, into the first stream. Accordingly, the memory system 1 can automatically change the relation between the stream and the input block without requiring a command for designating the relation between the stream and the input block given by the host 2. Therefore, the convenience of the memory system 1 can be improved.

The block allocation unit 103 allocates, to the new first input block, the second stream that is received first after the writing of the write data to the first input block in the second stream is finished (S312, No, S315 to S318). Accordingly, the change of the allocation of the input block between a stream and an input block can be performed with simple processing.

### Second Embodiment

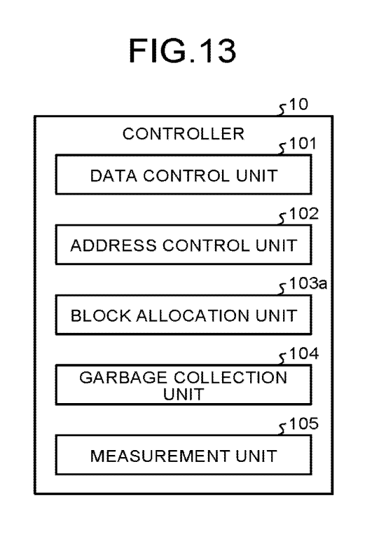

FIG. 13 is a figure for explaining an example of a configuration of functions provided in a controller 10 according to the second embodiment. The controller 10 includes a data control unit 101, an address control unit 102, a block allocation unit 103a, a garbage collection unit 104, and a measurement unit 105. The functions of the data control unit 101, the address control unit 102, and the garbage collection unit 104 are respectively the same as the functions of the constituent elements having the same names in the first embodiment.

The measurement unit 105 measures the amount of writing of each stream. For example, the number of inputs of write commands, or the total size of the write data may be employed as the amount of writing. In another example, the number of inputs of write commands or the total size of the write data in a predetermined period of time, e.g., the initial one minute, may be employed as the amount of writing. In still another example, the integration value of the number of inputs of write commands or the total size of the write data since the start of input may be employed as the amount of writing. Alternatively, a ratio of the amount of writing of each stream with respect to the amount of writing of all the streams in a predetermined period of time may be employed as the amount of writing of each stream. Still alternatively, a ratio of the amount of writing of each stream with respect to the amount of writing of all the streams in all the period may be employed as the amount of writing of each stream.

The block allocation unit 103a executes the change of the allocation of the input block on the basis of a measurement result of the amount of writing given by the measurement unit 105. For example, the block allocation unit 103a changes one of the second streams, of which amount of writing is the largest, to the first stream, and changes one of the first streams to the second stream.

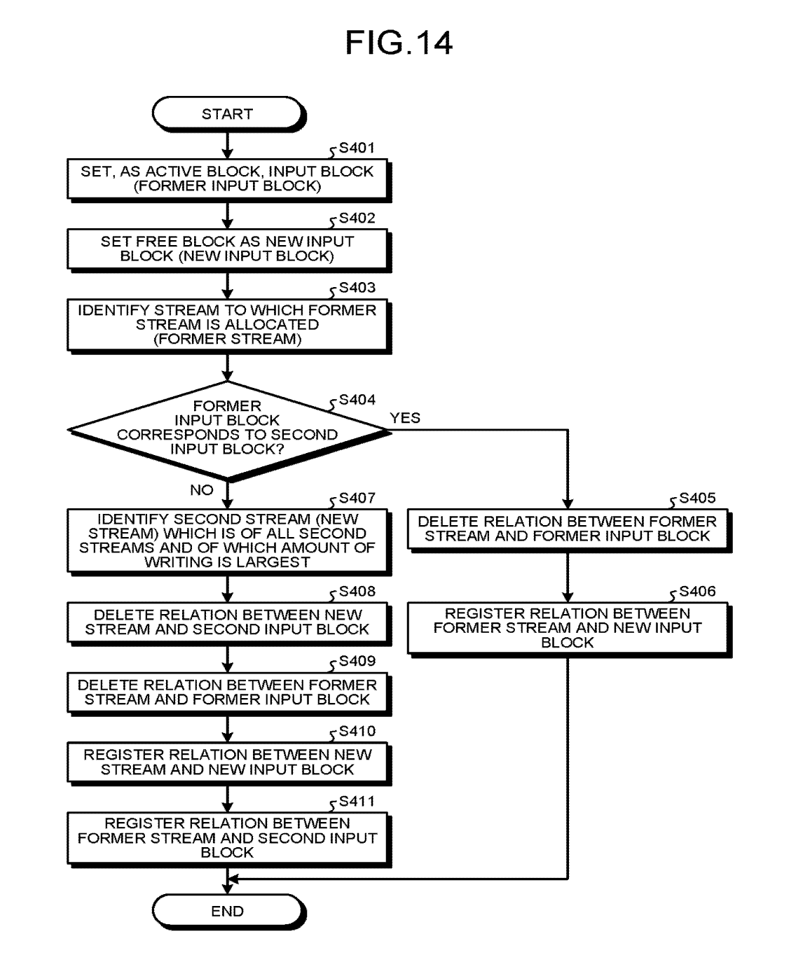

FIG. 14 is a flow chart for explaining an operation of the memory system 1 according to the second embodiment with regard to the change of the allocation of the input block. In a case where there is no longer any vacant area in the input block, the data control unit 101 sets, as an active block, the input block in which there is no longer any vacant area (S401). In the explanation about this drawing, the input block that is set as the active block in the processing of S401 will be denoted as a former input block. In the processing of S401, the data control unit 101 sets a single free block as a new input block (S402). In the explanation about this drawing, a new input block that is set in the processing of S402 will be denoted as a new input block.

The block allocation unit 103a identifies a stream to which the former input block is allocated (S403). In the explanation about this drawing, the stream identified in the processing of S403 will be denoted as a former stream. Further, the block allocation unit 103a determines whether the former input block corresponds to the second input block or not (S404).

In a case where former input block corresponds to the second input block (S404, Yes), the block allocation unit 103a deletes the relation between the former stream and the former input block (S405), and registers the relation between the former stream and the new input block (S406). In the processing of S406, the block allocation unit 103a records the new input block as the second input block. The processing of S405 and S406 can also be achieved by overwriting the block ID of the former input block recorded in the stream corresponding information 14 with the block ID of the new input block.

In a case where the former input block does not correspond to the second input block (S404, No), and more specifically, in a case where the former input block corresponds to the first input block, the block allocation unit 103a refers to the measurement value given by the measurement unit 105 to identify, from among all the second streams, a second stream of which amount of writing is the largest (S407). In the explanation about this drawing, the second stream identified in the processing of S407 will be denoted as a new stream.

In S408 to S411, the block allocation unit 103a executes the same processing as S315 to S318, and then, the processing of the change of the allocation of the input block is finished.

As described above, in the second embodiment, the block allocation unit 103a selects one of the second streams, and allocates the selected stream to the new input block (S407 to S411). Accordingly, the memory system 1 can automatically change the relation between the stream and the input block without requiring a command for designating the relation between the stream and the input block given by the host 2. Therefore, the convenience of the memory system 1 can be improved.

The block allocation unit 103a selects, from among the second streams, a stream of which amount of writing is the largest. Accordingly, the first input block can be efficiently allocated to the stream of which amount of writing is high, and therefore, the efficiency of the garbage collection is improved.

It should be noted that the block allocation unit 103a may be configured to perform selection of the second stream or exchange of the first stream and the second stream in accordance with any given method according to the amount of writing. For example, the block allocation unit 103a selects any given second stream of which amount of writing is larger than that of the former stream.

The block allocation unit 103a compares the amount of writing between the former stream and one of the second streams of which amount of writing is the largest, and executes change of the first stream and the second stream on the basis of the result of the comparison. More specifically, in a case where the amount of writing of the former stream is less than the amount of writing of one of the second streams of which amount of writing is the largest, the block allocation unit 103a changes the former stream to the second stream, and changes one of the second streams of which amount of writing is the largest to the first stream. In a case where the amount of writing of the former stream is more than the amount of writing of one of the second streams of which amount of writing is the largest, the block allocation unit 103a does not change the former stream to the second stream, and does not change one of the second streams of which amount of writing is the largest to the first stream.

In the above explanation, when the input block is caused to change to the active block, the change of the allocation of the input block is executed. Alternatively, the timing of the change from the input block to the active block may be determined on the basis of the amount of writing of each stream. For example, the block allocation unit 103a monitors the measurement result given by the measurement unit 105 for each stream, and in a case where the write data which belong to the first stream are not received for a predetermined period of time or more, the data control unit 101 sets, as an active block, the input block allocated to that first stream. Therefore, according to the processing as illustrated in FIG. 14, the change of the allocation of the input block is executed.

### Third Embodiment

In the first and second embodiments, when the writing to the input block is finished, the change of the allocation of the input block is executed. The execution timing of the change of the allocation of the input block is not limited to only the timing according to the finish of writing to the input block.

A memory system 1 according to the third embodiment is different from the memory system 1 according to the second embodiment in the function of the block allocation unit. The block allocation unit according to the third embodiment is denoted by a reference symbol 103b to be distinguished from the second embodiment.

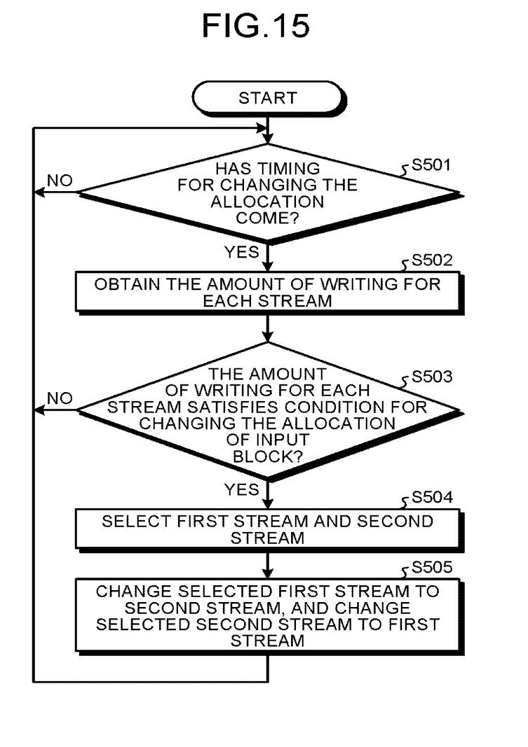

FIG. 15 is a flow chart for explaining an operation of the memory system 1 according to the third embodiment with regard to the change of the allocation of the input block.

First, the block allocation unit 103b determines whether a timing for changing the allocation has come or not (S501).

Any given timing may be employed as the setting of the timing for changing the allocation. For example, a timing on the basis of an elapsed time may be employed as the setting of the timing for changing the allocation. For example, in a case where the elapsed time from the timing of the previous change has attained a predetermined period of time, the block allocation unit 103b determines that the timing for the change is attained. The elapsed time for the timing for changing the allocation may be measured for each input block.

For example, the block allocation unit 103b monitors the amount of writing measured by the measurement unit 105 for each stream, and in a case where the amount of writing of each stream satisfies a condition for the change of the allocation of the input block, the timing for the change is determined to have come.

In a case where the timing for changing the allocation has not come (S501, No), the block allocation unit 103b executes the processing of S501 again. In a case where the timing for changing the allocation has come (S501, Yes), the block allocation unit 103b obtains the amount of writing of each stream (S502). Then, the block allocation unit 103b determines whether the amount of writing of each stream satisfies the condition for the change of the allocation of the input block or not (S503).

Any given condition may be employed as the condition for the change of the allocation of the input block as long as it is a condition based on the amount of writing of each stream. An example of a condition for a change of the allocation of the input block will be explained below.

### (First Condition)

According to the first condition, when the amount of writing of at least one first stream is less than the amount of writing of one of the second streams of which amount of writing is the largest, this is determined to satisfy the condition for the change of the allocation of the input block. In other words, when the amount of writing of any first stream is more than the amount of writing of one of the second streams of which amount of writing is the largest, this is determined not to satisfy the condition for the change of the allocation of the input block.

### (Second Condition)

According to second condition, when the amount of writing of at least one first stream is less than a predetermined threshold value, this may be determined to satisfy the condition for the change of the allocation of the input block. In other words, when the amount of writing of any first stream is more than the threshold value, this is determined not to satisfy the condition for the change of the allocation of the input block.

### (Third Condition)

According to the third condition, when the amount of writing of at least one second stream is more than a predetermined threshold value, this is determined to satisfy the condition for the change of the allocation of the input block. In other words, when the amount of writing of any second stream is less than the threshold value, this is determined not to satisfy the condition for the change of the allocation of the input block.

In a case where the amount of writing of each stream does not satisfy the condition for the change of the allocation of the input block (S503, No), the block allocation unit 103b executes the processing of S501 again. In a case where the amount of writing of each stream satisfies the condition for the change of the allocation of the input block (S503, Yes), the block allocation unit 103b selects a single first stream and a single second stream (S504).

Any given criteria may be employed as the criteria for selection of each stream as long as it is based on the amount of writing of each stream.

In a case where the first condition is employed as the condition for the change of the allocation of the input block, for example, a second stream of which amount of writing is the largest is selected, and a first stream of which amount of writing is less than the selected second stream is selected. In a case where the first condition is employed as the condition for the change of the allocation of the input block, a first stream of which amount of writing is the smallest may be selected.

In a case where the second condition is employed as the condition for the change of the allocation of the input block, for example, a first stream of which amount of writing is less than a threshold value used for the second condition is selected, and any given second stream is selected. In a case where the second condition is employed as the condition for the change of the allocation of the input block, any given second stream of which amount of writing is more than the selected first stream may be selected, or one of the one or more second streams of which amount of writing is the largest may be selected.

In a case where the third condition is employed as the condition for the change of the allocation of the input block, for example, a second stream of which amount of writing is more than a threshold value used for the third condition is selected, and any given first stream is selected. In a case where the third condition is employed as the condition for the change of the allocation of the input block, any given first stream of which amount of writing is less than the selected second stream may be selected, or a first stream chosen from among one or more first streams and of which amount of writing is the smallest may be selected.

Regardless of the condition for the change of the allocation of the input block, any given second stream may be selected, and a first stream of which amount of writing is less than the selected second stream may be selected. Regardless of the condition for the change of the allocation of the input block, any given first stream may be selected, and a second stream of which amount of writing is more than the selected first stream may be selected.

After the processing of S504, the block allocation unit 103b updates the stream corresponding information 14 to change the selected first stream to the second stream and changes the selected second stream to the first stream (S505). For example, the block allocation unit 103b associates the second input block allocated to the selected second stream with the selected first stream, and associates the first input block allocated to the selected first stream with the selected second stream.

After the processing of S505, the block allocation unit 103b executes the processing of S501 again. After the processing of S505, the block allocation unit 103b may execute the processing of S503 again.

After the processing of S504, the block allocation unit 103b may cause the first input block allocated to the selected first stream to be changed to the active block, and may set a single free block as a new first input block, and thereafter, the processing of S505 may be executed. For example, when the first input block allocated to the selected first stream is caused to be changed to the active block, the block allocation unit 103b may pad the vacant area with predetermined data. For example, the block allocation unit 103b may temporarily associate a new first input block with the selected first stream, and thereafter, execute the processing of S505 after the writing to the new first input block is started.

As described above, according to the third embodiment, after any condition that has been set is satisfied, the block allocation unit 103b executes the change of the allocation of the input block. The block allocation unit 103b selects the second stream, which is to be changed, on the basis of the amount of writing. Accordingly, even in a case where the input block is not newly set, the memory system 1 can execute the change of the allocation of the input block. Therefore, the convenience of the memory system 1 can be improved.

As described above, the timing according to the elapsed time or the timing according to the amount of writing may be employed as the condition for the change of the allocation of the input block.

### Fourth Embodiment

In the memory system 1 according to the first to third embodiments, in a case where the block allocation unit receives write data which belong to a new stream, the second input block may be allocated to the new stream. The new stream means a stream for which relation is not recorded in the stream corresponding information 14. The block allocation unit may change any given first stream of one or more first streams to the second stream, and may set the new stream to the first stream. The block allocation unit may select, as the first stream which is to be changed to the second stream, a first stream of one or more first streams of which amount of writing is the minimum. In a case where the OS 20 transmits write data which belong to a new stream, the OS 20 notifies the new stream to the memory system 1, and the block allocation unit carries out allocation of an input block to the new stream in response to reception of the notification.

In a case where write data which belong to the second stream are not thereafter received, the block allocation unit may delete the relation between the second stream and the second input block. In a case where write data which belong to the first stream are not thereafter received, the block allocation unit may delete the relation between the first stream and the first input block, and may change any given second stream to the first stream. The block allocation unit may select, as the second stream which is to be changed to the first stream, a second stream of one or more second stream of which amount of writing is the largest. In a case where the OS 20 does not thereafter transmit write data which belong to a single stream, the OS 20 notifies the stream, in which the write data are not thereafter transmitted, to the memory system 1, and the block allocation unit carries out change of allocation in response to reception of the notification.

### Fifth Embodiment

The memory system 1 according to the first to fourth embodiments may be configured to be able to receive a write IO provided with a write command not including any stream ID. For example, the data control unit 101 writes write data that do not belong to any stream to the second input block. Alternatively, a third input block that is different from both of the first input block and the second input block is set, and the data control unit 101 writes the write data which do not belong to any stream to the third input block.

### Sixth Embodiment

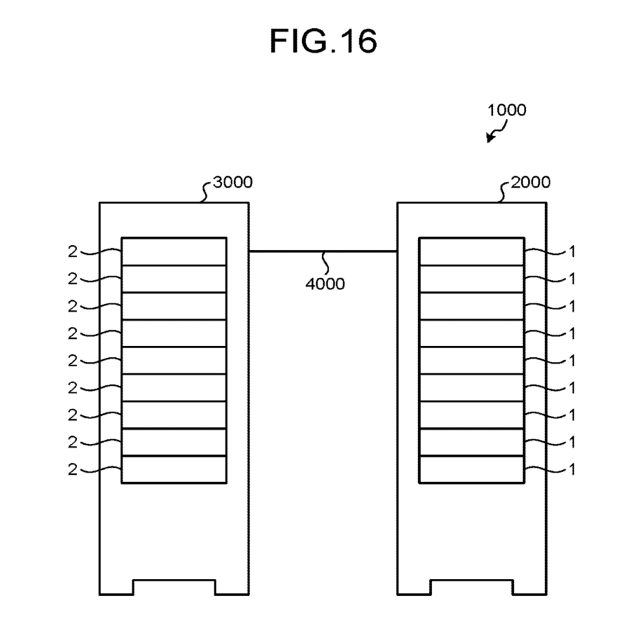

FIG. 16 is a figure illustrating an example of an implementation of a memory system 1. The memory system 1 is implemented on, for example, a server system 1000. The server system 1000 includes a disk array 2000 and a rack mount server 3000. The disk array 2000 and the rack mount server 3000 are connected via a communication interface 4000. Any given standard may be employed as the standard for the communication interface 4000.

The rack mount server 3000 includes a server rack, and one or more hosts 2 are installed on the server rack. The disk array 2000 includes a server rack, and one or more memory systems 1 are installed on the server rack. Each host 2 can transmit a write IO to each memory system 1 constituting the disk array 2000 via the communication interface 4000.

Each memory system 1 has a configuration employing any one of the first to sixth embodiments. Therefore, each memory system 1 can automatically update the relation between the stream and the input block. The necessity of the command for the relation between the stream and the input block given by each host 2 can be eliminated, and therefore, the convenience of each memory system 1 can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory that includes a plurality of unit areas, the unit area being a unit of erase processing of data;
an interface that receives a plurality of write data each to which a stream identifier is given;
a controller circuit that writes, to a first unit area, write data which is received by the interface and to which one stream identifier is given, the first unit area being one of the plurality of unit areas and being a unit area to which the one stream identifier is associated; and
an allocator that sets another unit area to a new first unit area after the first unit area becomes full, and associates another stream identifier different from the one stream identifier with the new first unit area.

2. The memory system according to claim 1, wherein the plurality of unit areas include a second unit area different from the first unit area,
the controller circuit writes, to the second unit area, write data which are of write data received by the interface and to which a stream identifier not associated with the first unit area is given, and
the allocator selects the other stream identifier from the stream identifier of write data of which destination of writing is the second unit area.

3. The memory system according to claim 2, wherein
the stream identifier of write data of which destination of writing is the second unit area includes a plurality of stream identifiers,
the allocator selects, on the basis of an amount of writing, the other stream identifier from the plurality of stream identifiers.

4. The memory system according to claim 3, wherein the allocator selects, as the other stream identifier, a stream identifier of which amount of writing is the largest among the plurality of stream identifiers.

5. The memory system according to claim 3, wherein the allocator selects, as the other stream identifier, a stream identifier of which amount of writing is larger than an amount of writing of the one stream identifier among the plurality of stream identifiers.

6. The memory system according to claim 1, wherein the plurality of unit areas include a second unit area different from the first unit area,
the controller circuit writes, to the second unit area, write data which are of write data received by the interface and to which a stream identifier not associated with the first unit area is given,
the stream identifier of write data of which destination of writing is the second unit area includes a plurality of stream identifiers, and
the allocator selects, as the other stream identifier, a stream identifier of write data received first after writing of write data to the first unit area is finished among the plurality of stream identifiers.

7. The memory system according to claim 1, wherein the first unit area is a unit area associated with only a single stream identifier.

8. A memory system comprising:
a nonvolatile memory that includes a plurality of unit areas, the unit area being a unit of erase processing of data;
an interface that receives a plurality of write data each to which a stream identifier is given;
a controller circuit that writes, to a first unit area, write data which is received by the interface and to which one stream identifier is given, the first unit area being one of the plurality of unit areas and being a unit area to which the one stream identifier is associated; and
an allocator that selects, on the amount of writing, another stream identifier different from the one stream identifier, and changes a stream identifier associated to the first unit area from the one stream identifier to the other stream identifier.

9. The memory system according to claim 8, wherein the plurality of unit areas include a second unit area different from the first unit area,
the controller circuit writes, to the second unit area, write data which are of write data received by the interface and to which a stream identifier not associated with the first unit area is given,
the stream identifier of write data of which destination of writing is the second unit area includes a plurality of stream identifiers, and
the allocator selects the other stream identifier from the plurality of stream identifiers.

10. The memory system according to claim 9, wherein the allocator selects, as the other stream identifier, a stream identifier of which amount of writing is the largest among the plurality of stream identifiers.

11. The memory system according to claim 9, wherein the allocator selects, as the other stream identifier, a stream identifier of which amount of writing is larger than an amount of writing of the one stream identifier among the plurality of stream identifiers.

12. The memory system according to claim 8, wherein the first unit area is a unit area associated with only a single stream identifier.

13. The memory system according to claim 8, wherein the allocator executes change of a stream identifier associated with the first unit area at a timing based on an elapsed time.

14. The memory system according to claim 8, wherein the allocator executes change of a stream identifier corresponding to the first unit area in a case where the amount of writing satisfies a predetermined condition.

15. A host apparatus connectable to a memory system, wherein the host apparatus gives different stream identifiers to two write data, and transmits the two write data to the memory system.

16. The host apparatus according to claim 15, wherein the host apparatus gives stream identifiers according to a user name, a file name, an application identifier, a thread identifier, or a virtual machine identifier to the two write data.

17. A memory system comprising:
a nonvolatile memory that includes a plurality of unit areas, the unit area being a unit of erase processing of data;
a first unit that receives a plurality of write data each to which a stream identifier is given;
a second unit that writes, to a first unit area, write data which is received by the first unit and to which one stream identifier is given, the first unit area being one of the plurality of unit areas and being an area to which the one stream identifier is associated;
a third unit that sets, as a new first unit area, another unit area after the first unit area becomes full, and associates another stream identifier different from the one stream identifier with the new first unit area.
